(19) United States
(12) Patent Application Publication
(10) Pub. No.: US 2007/0217444 A1
(43) Pub. Date: Sep. 20, 2007

(54) Computer

(75) Inventors: Yoshikatsu Kouhara, Fukuoka (JP); Yoshinori Soejima, Fukuoka (JP); Hiroaki Shiraishi, Fukuoka (JP); Kouichi Tanda, Fukuoka (JP); Takakazu Tokunaga, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/711,806

(22) Filed: Feb. 28, 2007

(30) Foreign Application Priority Data
Mar. 15, 2006 (JP) 2006-070803

(51) Int. Cl. H04L 12/66

(52) U.S. Cl. 370/463

(57) ABSTRACT

A computer capable of easily obtaining RTL of a TOP circuit after a block circuit is separated out of the TOP circuit. A port information input unit inputs the port information of the TOP circuit described in RTL, and the port information of block circuits composing the TOP circuit, from a user. A separation information input unit inputs separation information specifying a block circuit to be separated out of the TOP circuit, from the user. A separation port information creation unit creates separation port information after the block circuit is separated, by changing the port information of the TOP circuit and the block circuits based on the port information of the block circuit to be separated according to the separation information. An RTL rewriting unit rewrites RTL of the TOP circuit from which the block circuit has been separated, based on the separation port information created by the separation port information creation unit.

### CROSS-REFERENCE TO RELATED APPLICATIONS

This application is based upon and claims the benefits of priority from the prior Japanese Patent Application No. 2006-070803, filed on Mar. 15, 2006, the entire contents of which are incorporated herein by reference.

### BACKGROUND OF THE INVENTION

(1) Field of the Invention

This invention relates to a computer, and particularly to a computer for designing circuits.

(2) Description of the Related Art

In development flows of Application Specific Integrated Circuits (ASIC), a Field Programmable Gate Array (FPGA) is often used as a prototype for verifying operation of an ASIC. Then, after the actual operation is confirmed by using such a reprogrammable FPGA, ASICs are produced, thereby realizing cost reduction.

For ASICs, Intellectual Property (IP) macros are provided from a third vender or the like, and specified functions can be treated as a black box. A contract may allow using the provided IP macros not for FPGAs but for ASICs. If a development flow using an FPGA is employed, an IP macro, which is not allowed to be used, should be separated out of the FPGA (top circuit), and another device should be used instead of the IP macro.

FIG. 37 is a diagram of a circuit to be realized by an ASIC. Referring to FIG. 37, a circuit 200 has functional blocks 201 and 202 designed by a designer, and an IP macro 203 provided from a third vender or the like. The circuit 200, the functional blocks 201 and 202, and the IP macro 203 are described in Register Transfer Level (RTL). It is assumed that a contract rules that the IP macro 203 can be used for ASICs but not for FPGAs.

An FPGA is used for verifying the operation of the circuit 200. In this case, since the IP macro 203 cannot be used for FPGAs, the IP macro 203 should be separated out of the circuit 200 (top circuit) and replaced with another device. That is to say, the RTL needs to be rewritten so that the IP macro 203 is separated out of the circuit 200.

FIG. 38 is a diagram of a circuit from which the IP macro has been separated. Since the IP macro 203 cannot be used for FPGAs, the IP macro 203 should be separated out of a circuit 210 as shown in FIG. 38. Then, the separated IP macro 203 is replaced with a device or the like (for example, commercial ASIC) having equivalent functions. By mounting thus designed FPGA of the circuit 210, the device that is used instead of the separated IP macro 203, and so on, on a board, operation of the circuit that is like being realized by an ASIC can be verified.

Conventionally, a design technique of automatically inserting I/F circuits between circuits or adding I/F circuits to circuits has been proposed (for example, refer to Japanese Unexamined Patent Publication No. 2001-142923). In addition, a design technique of arranging and connecting input/output buffers with optimal timing between IPs (IP macros) has been proposed (for example, refer to Japanese Unexamined Patent Publication No. 2000-286342).

However, separation of a block circuit (IP macro) out of a top circuit requires manual rewriting of RTL descriptions. Therefore, if a circuit scale is large, the rewriting operation is complicated and difficult.

### SUMMARY OF THE INVENTION

This invention has been made in view of foregoing and intends to provide a computer for separating a block circuit out of a top circuit with ease.

To accomplish the above problem, there is provided a computer for designing a circuit. This computer comprises: a port information input unit for inputting port information of a TOP circuit described in register transfer level (RTL) and block circuits composing the TOP circuit; a separation information input unit for inputting separation information specifying a separation block circuit to be separated out of the TOP circuit; a separation port information creator for creating separation port information after the separation block circuit is separated, by changing the port information of the TOP circuit and the block circuits based on the port information of the separation block circuit to be separated according to the separation information; and an RTL rewriting unit for rewriting the RTL of the TOP circuit from which the separation block circuit has been separated, based on the separation port information.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIGS. 1A and 1B show the outline of a computer.

FIG. 2 shows an example of a circuit described in RTL.

FIG. 3 is a diagram for explaining how a computer separates an IP macro.

FIG. 4 is a diagram for explaining how a computer adds an IP macro.

FIG. 5 is a diagram for explaining how a computer adds and separates IP macros.

FIGS. 6 and 7 are a flowchart describing how a computer separates, adds, and adds and separates IP macros.

FIG. 8 is a functional block diagram of the computer.

FIG. 9 shows a circuit before the computer separates an IP macro.

FIG. 10 shows a circuit after the computer separates the IP macro.

FIG. 11 shows a port information file of TOP1 to be inputted to the computer.

FIG. 12 shows a port information file of FUNC1 to be inputted to the computer.

FIG. 13 shows a port information file of FUNC2 to be inputted to the computer.

FIG. 14 shows a port information file of IP1 to be inputted to the computer.

FIG. 15 shows a setting file to be inputted to the computer.

FIG. 16 shows a port information file of TOP1 after the separation.

FIG. 17 shows a port information file of FUNC1 after the separation.

FIG. 18 shows a port information file of FUNC2 after the separation.

FIGS. 19 and 20 show RTL of TOP1 to be inputted to the computer.

FIG. 21 shows RTL of IP1 to be inputted to the computer.

FIG. 22 shows RTL of TOP1 after the separation of IP1.

FIG. 23 is a flowchart describing how to create port information files when an IP macro is separated.

FIG. 24 shows a circuit before the computer adds an IP macro.

FIG. 25 shows a circuit after the computer adds the IP macro.

FIG. 26 shows a port information file of TOP2 to be inputted to the computer.

FIG. 27 shows a port information file of IP2 to be inputted to the computer.

FIG. 28 shows a setting file to be inputted to the computer.

FIG. 29 shows a port information file of TOP3 after the addition.

FIG. 30 shows a port information file of FUNC1 after the addition.

FIG. 31 shows a port information file of FUNC2 after the addition.

FIG. 32 shows RTL of IP2 to be inputted to the computer.

FIGS. 33 and 34 show RTL of TOP3 after IP2 is added.

FIG. 35 is a flowchart describing how to create port information files when an IP macro is added.

FIG. 36 shows conversion of a port format.

FIG. 37 is a diagram of a circuit to be realized by an ASIC.

FIG. 38 is a diagram of a circuit from which an IP macro has been separated.

### DESCRIPTION OF THE PREFERRED EMBODIMENTS

Preferred embodiments of this invention will be described with reference to the accompanying drawings.

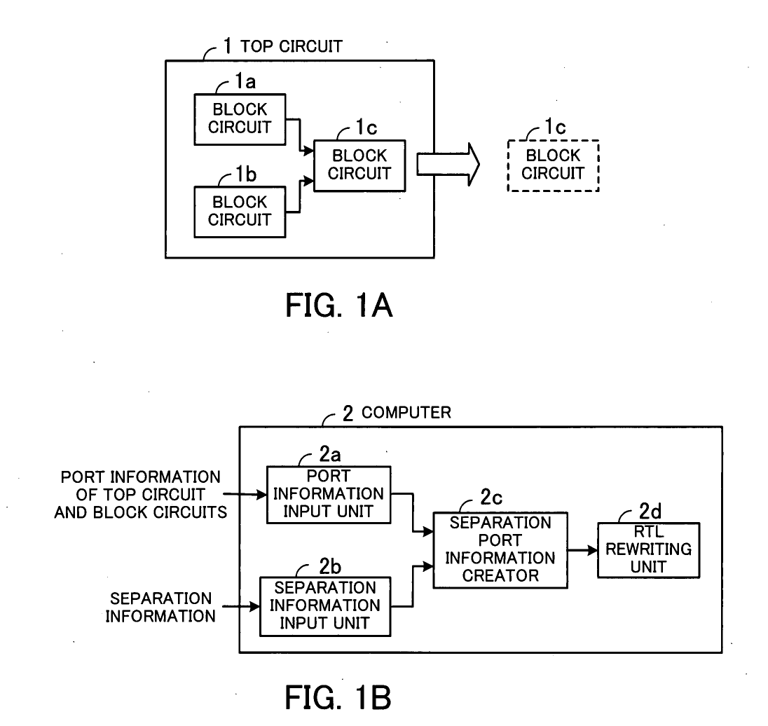

FIGS. 1A and 1B show the outline of a computer. FIG. 1A shows a top circuit 1 and block circuits 1a to 1c composing the top circuit 1. FIG. 1B shows a computer 2. The top circuit 1 and the block circuits 1a to 1c are described in RTL and the RTL data of the circuits is inputted to the computer 2.

The computer 2 has a port information input unit 2a, a separation information input unit 2b, a separation port information creator 2c, and an RTL rewriting unit 2d.

The port information input unit 2a inputs port information of the top circuit 1 and the block circuits 1a to 1c composing the top circuit 1, from a user, the top circuit 1 and the block circuits 1a to 1c being described in RTL. The port information includes the names of ports, the names of connection circuits, and the names of connection ports, with respect to the top circuit 1 and the block circuits 1a to 1c.

The separation information input unit 2b inputs separation information specifying a block circuit (separation block circuit) to be separated out of the top circuit 1 from the user. In this connection, in the example of FIGS. 1A and 1B, the block circuit 1c is to be separated out of the top circuit 1 and therefore the separation information specifies the block circuit 1c.

The separation port information creator 2c changes the port information of the top circuit 1 and the block circuits 1a and 1b based on the port information of the block circuit 1c to be separated according to the separation information, and thereby creates separation port information after the separation of the block circuit 1c. That is to say, when the block circuit 1c is separated out of the top circuit 1, the port information of the top circuit 1 and the block circuits 1a and 1b should be changed. The separation port information creator 2c creates separation port information by changing the port information.

The RTL rewriting unit 2d rewrites the RTL of the top circuit 1 from which the block circuit 1c has been separated, based on the separation port information created by the separation port information creator 2c.

As described above, the computer 2 changes the port information of the top circuit 1 and the block circuits 1a and 1b, based on the port information of the block circuit 1c to be separated out of the top circuit 1, to thereby create separation port information after the separation of the block circuit 1c, and rewrites the RTL of the top circuit 1. Thereby the RTL of the top circuit 1 from which the separation block circuit has been separated can be obtained automatically, not manually, resulting in separating the block circuit 1c from the top circuit 1 with ease.

Now, one embodiment of this invention will be described in detail with reference to the drawings. A circuit to be designed in RTL will be described first.

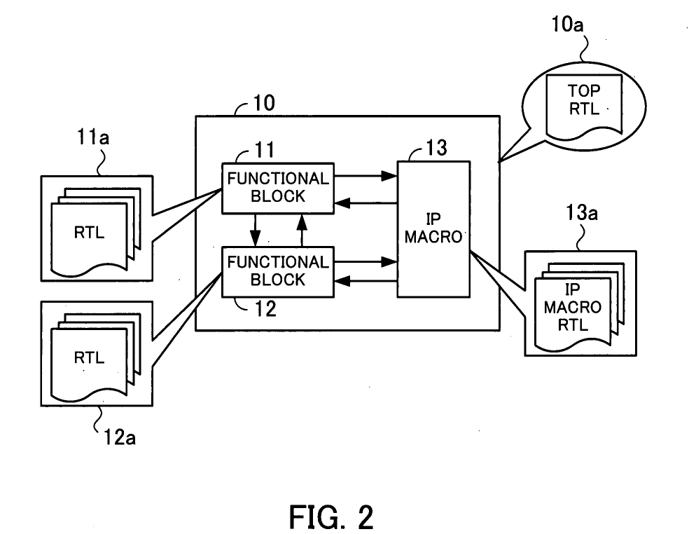

FIG. 2 shows an example of a circuit described in RTL. RTL allows to hierarchically design a circuit with blocks. FIG. 2 shows a TOP circuit 10, and functional blocks 11 and 12 and an IP macro 13 which compose the TOP circuit 10.

The TOP circuit 10 is a top layer circuit of the circuit described in RTL. The TOP circuit 10 is equivalent to an entire chip. The configuration of the TOP circuit 10 is described by TOP RTL 10a. The TOP RTL 10a describes circuits (functional blocks 11 and 12 and IP macro 13) composing the TOP circuit 10. The details of the circuits composing the TOP circuit 10 are written by lower-level descriptions of the RTL.

The functional blocks 11 and 12 and the IP macro 13 are main circuits that compose the TOP circuit 10. The configurations of the functional blocks 11 and 12 are described by RTL 11a and 12a of FIG. 2. The configuration of the IP macro 13 is described by IP macro RTL 13a. The functional blocks 11 and 12 are circuits designed by a user, and the IP macro 13 is an IP macro provided from a third vender, for example. As described above, circuits can be designed in RTL.

Now, separation, addition, and addition/separation of IP macros to be performed by a computer will be summarized. The separation of an IP macro by the computer will be described first.

IP macros can be used for ASICs but may not be used for FGPAs. In this case, the RTL descriptions should be rewritten so that the unusable IP macros are separated out of the chip.

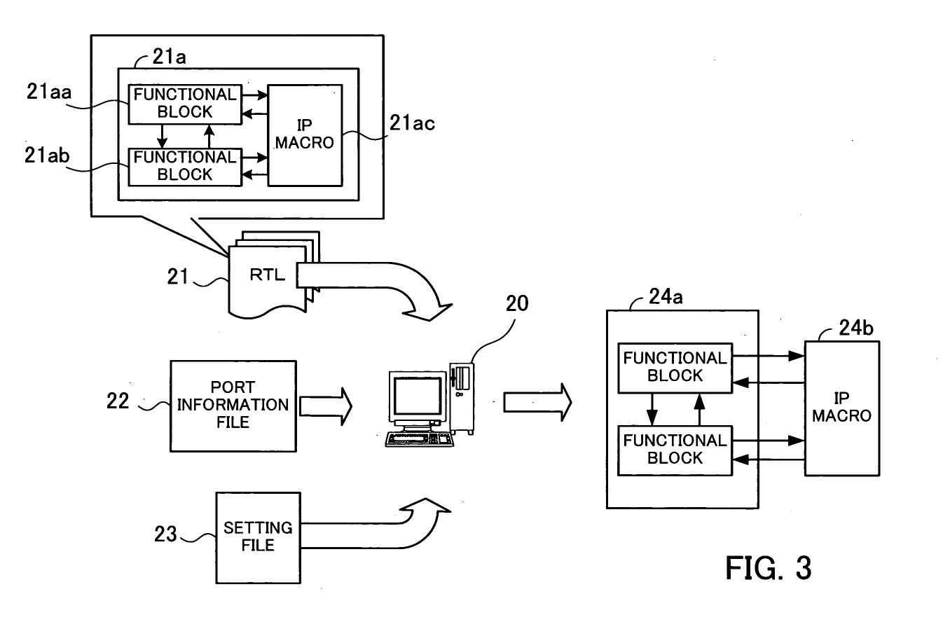

FIG. 3 shows separation of an IP macro to be performed by a computer. FIG. 3 shows a computer 20 that separates an IP macro. RTL 21 describing a circuit is inputted to the computer 20. The circuit comprises the TOP circuit 21a, and functional blocks 21aa and 21ab and an IP macro 21ac composing the TOP circuit 21a.

Further, a port information file 22 containing port information of the TOP circuit 21a, the functional blocks 21aa and 21ab, and the IP macro 21ac is inputted to the computer 20. Furthermore, a setting file 23 indicating how to treat a prescribed IP macro with respect to the TOP circuit 21a, separation, addition, or addition and separation is inputted to the computer 20. It is now assumed that the setting file 23 indicates separation of the IP macro 21ac from the TOP circuit 21a.

The computer 20 separates the IP macro 21ac from the TOP circuit 21a according to the setting file 23. At this time, the computer 20 separates the IP macro 21ac based on the inputted port information file 22. Then the computer 20 automatically creates RTL of a TOP circuit 24a from which an IP macro 24b has been separated.

As described above, the computer 20 separates the circuit into the TOP circuit 24a and the IP macro 24b and creates the RTL of the TOP circuit 24a, based on the RTL 21 describing the circuit, the port information file 22, and the setting file 23, as shown in FIG. 3.

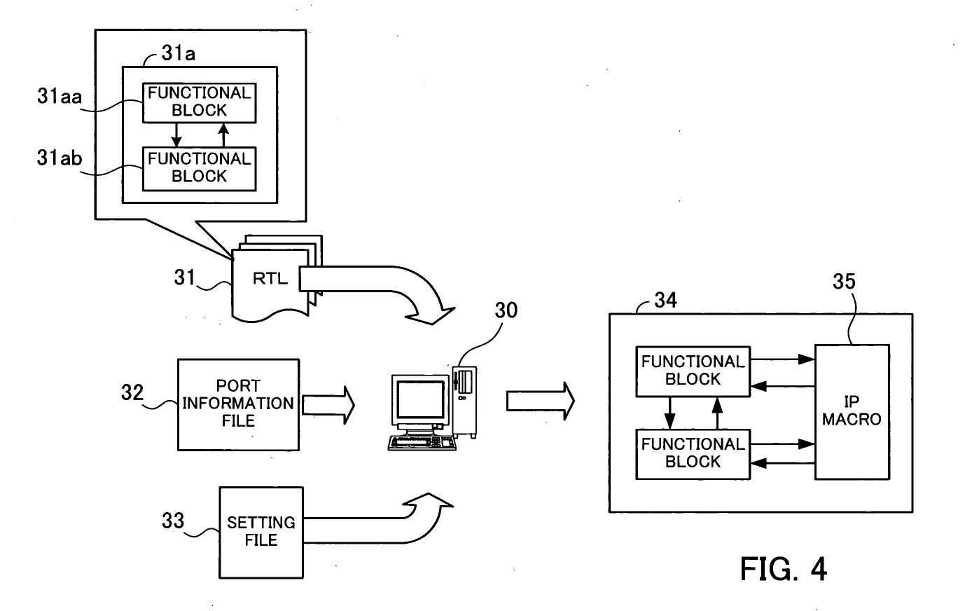

Now, addition of an IP macro to be performed by a computer will be described with reference to FIG. 4.

FIG. 4 shows a computer 30 that adds an IP macro. RTL 31 describing a circuit is inputted to the computer 30. The circuit comprises a TOP circuit 31a, and functional blocks 31aa and 31ab composing the TOP circuit 31a.

Further, a port information file 32 containing port information of the TOP circuit 31a, the functional blocks 31aa and 31ab, and an IP macro 35 to be added to the TOP circuit 31a is inputted to the computer 30.

Furthermore, a setting file 33 indicating how to treat a prescribed IP macro with respect to the TOP circuit 31a, separation, addition, or addition and separation is inputted to the computer 30. It is now assumed that the setting file 33 indicates addition of the IP macro 35 to the TOP circuit 31a.

The computer 30 adds the IP macro 35 to the TOP circuit 31a according to the setting file 33. At this time, the computer 30 adds the IP macro 35 based on the inputted port information file 32. Then the computer 30 automatically creates RTL of a TOP circuit 34 formed by adding the IP macro 35.

As described above, the computer 30 forms the TOP circuit 34 by adding the IP macro 35 to the TOP circuit 31a and creates the RTL of the TOP circuit 34, based on the RTL 31 describing the circuit, the port information file 32, and the setting file 33.

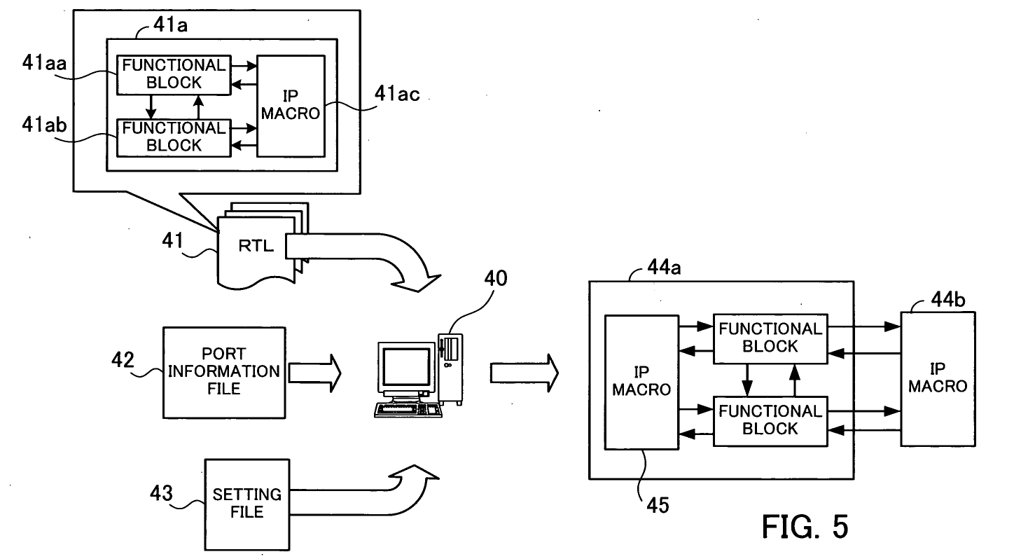

Now addition and separation of IP macros to be performed by a computer will be described with reference to FIG. 5.

FIG. 5 shows a computer 40 that adds and separates IP macros. RTL 41 describing a circuit is inputted to the computer 40. The circuit comprises a TOP circuit 41a, and functional blocks 41aa and 41ab and an IP macro 41ac composing the TOP circuit 41a.

Further, a port information file 42 containing port information of the TOP circuit 41a, the functional blocks 41aa and 41ab, the IP macro 41ac to be separated from the TOP circuit 41a, and an IP macro 45 to be added to the TOP circuit 41a is inputted to the computer 40.

Furthermore, a setting file 43 indicating how to treat prescribed IP macros with respect to the TOP circuit 41a, separation, addition, or addition and separation is inputted to the computer 40. It is now assumed that the setting file 43 indicates separation of the IP macro 41ac from the TOP circuit 41a and addition of the IP macro 45 to the top circuit 41a.

The computer 40 adds the IP macro 45 to the TOP circuit 41a according to the setting file 43. In addition the computer 40 separates the IP macro 41ac from the TOP circuit 41a. At this time, the computer 40 separates the IP macro 41ac and adds the IP macro 45, based on the inputted port information file 42. Then the computer 40 automatically creates RTL of a TOP circuit 44a formed by separating the IP macro 44b and adding the IP macro 45.

As described above, the computer 40 forms the TOP circuit 44a by separating the IP macro 44b and adding the IP macro 45 and crates the RTL of the TOP circuit 44a, based on the RTL 41 describing the circuit, the port information file 42, and the setting file 43.

The computers 20 to 40 described with FIGS. 3 to 5 were separately described for separation, addition, and addition and separation of IP macros. It should be noted that a single computer is capable of separating, adding, and separating and adding IP macros. In the following description, a single computer separates, adds, and adds and separates IP macros.

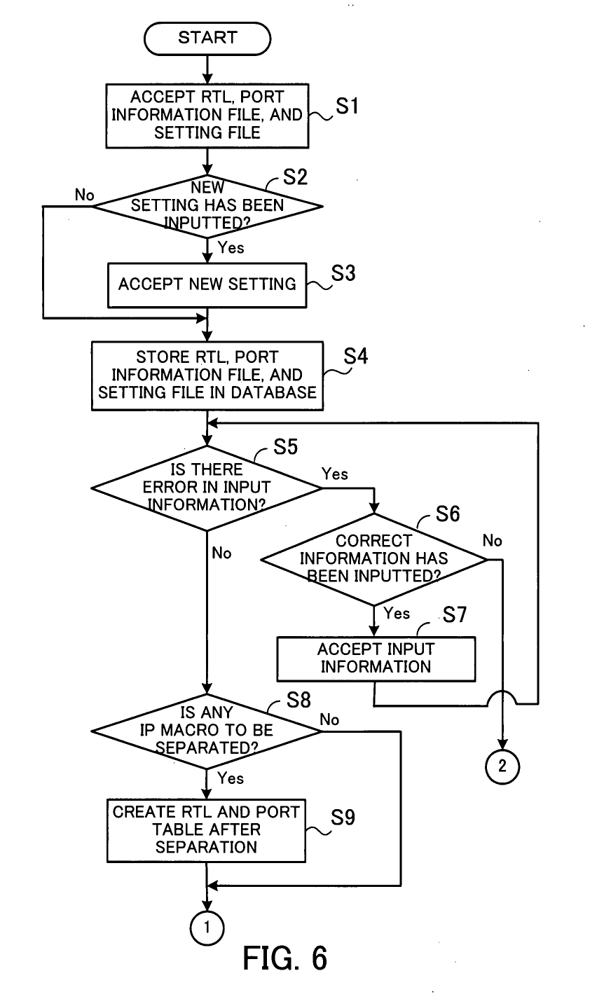

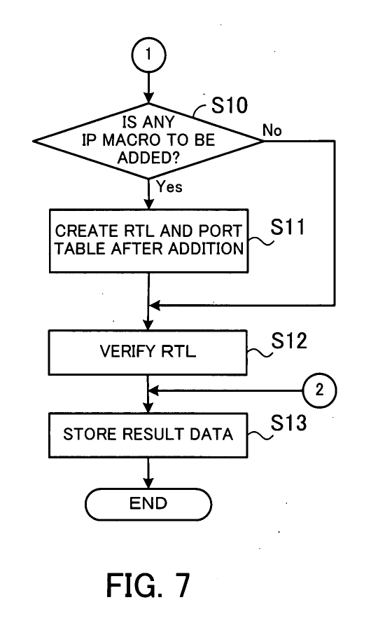

FIGS. 6 and 7 are a flowchart showing how a computer separates, adds, and adds and separates IP macros.

(Step S1) The computer accepts RTL of a TOP circuit, a port information file, and a setting file from a user.

(Step S2) The computer determines whether new setting has been inputted from the user. For example, the user may desire to partly change the RTL, the port information file, or the setting file, which were inputted at step S1. For this case, the computer accepts new setting from the user. If new setting has been inputted, the procedure goes on to step S3, and otherwise goes on to step S4.

(Step S3) The computer accepts the new setting from the user.

(Step S4) The computer stores the inputted RTL, port information file, and setting file in a database created in a memory device such as Hard Disk Drive (HDD).

(Step S5) The computer determines whether there are errors in the input information (RTL, port information file, and setting file). For example, the descriptions of the input information are checked to see whether they have mistakes. If there are errors in the input information, the procedure goes on to step S6, and otherwise goes on to step S8.

(Step S6) The computer determines whether correct information has been inputted from the user. If yes, the procedure goes on to step S7, and otherwise goes on to step S13.

(Step S7) The computer accepts the correct information from the user and then the procedure goes on to step S5.

(Step S8) The computer determines based on the setting file inputted at step S1 whether to separate an IP macro. If yes, the procedure goes on to step S9, and otherwise goes on to step S10.

(Step S9) The computer crates a port table (port information file) and RTL after the separation of the IP macro.

(Step S10) The computer determines based on the setting file inputted at step S1 whether to add an IP macro. If yes, the procedure goes on to step S11, and otherwise goes on to step S12.

(Step S11) The computer creates a port table and RTL after the addition of the IP macro.

(Step S12) The computer verifies whether the RTL descriptions are correct. For example, the RTL descriptions are checked to see whether they have mistakes.

(Step S13) The computer stores the created RTL and port table in a database.

As described above, the computer separates, adds, and separates and adds IP macros.

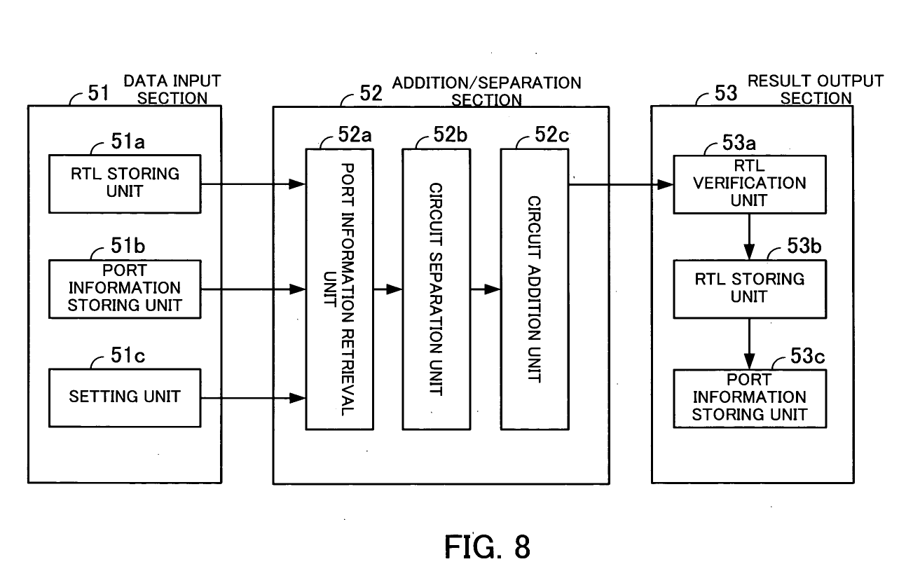

Now the functions of the computer will be described with reference to FIG. 8. Referring to FIG. 8, the computer has a data input section 51, an addition/separation section 52, and a result output section 53.

The data input section 51 has an RTL storing unit 51a, a port information storing unit 51b, and a setting unit 51c. The RTL storing unit 51a accepts RTL of a circuit and stores it in a memory unit such as HDD. The port information storing unit 51b accepts a port information file from the user and stores it in the memory unit such as HDD. The setting unit 51c accepts a setting file from the user and stores it in the memory unit such as HDD.

The addition/separation section 52 has a port information retrieval unit 52a, a circuit separation unit 52b, and a circuit addition unit 52c. The port information retrieval unit 52a retrieves a port information file from the memory unit. The circuit separation unit 52b separates an IP macro specified by the setting file from a TOP circuit and creates RTL of a TOP circuit formed by separating the IP macro, based on the retrieved port information file. The circuit addition circuit 52c adds an IP macro specified by the setting file to the TOP circuit and creates RTL of a TOP circuit formed by adding the IP macro, based on the retrieved port information file.

The result output section 53 has an RTL verification unit 53a, an RTL storing unit 53b, and a port information storing unit 53c. The RTL verification unit 53a verifies the RTL created by the addition/separation section 52. For example, the RTL descriptions are checked to see whether they have no mistake. The RTL storing unit 53b stores the verified RTL in a memory unit such as HDD. The port information storing unit 53c stores a port information file created by the addition/separation section 52 in the memory unit such as HDD.

The specific operation of the computer will be described. The computer separating an IP macro and then the computer adding an IP macro will be described.

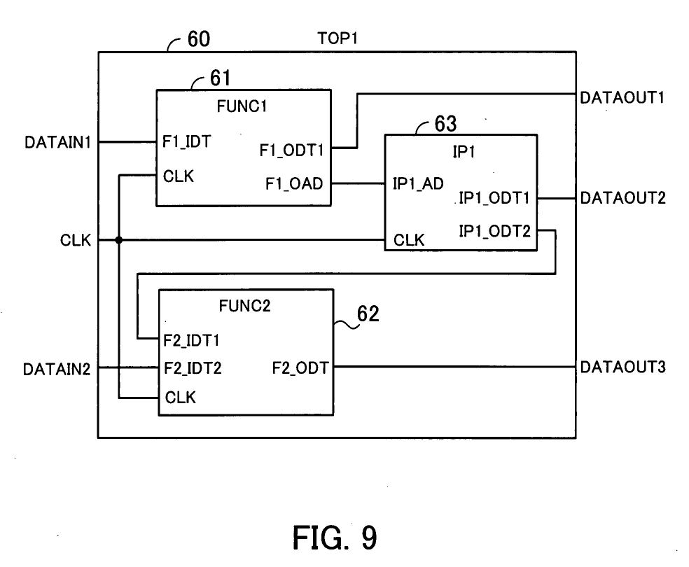

FIG. 9 shows a circuit before separation. FIG. 9 shows a top-layer TOP circuit 60 described in RTL, and functional blocks 61 and 62 and an IP macro 63 which compose the TOP circuit 60. In the following description, the TOP circuit 60, the functional blocks 61 and 62, and the IP macro 63 are referred to as TOP1, FUNC1 and FUNC2, and IP1, as shown in FIG. 9.

TOP1 has ports DATAIN1, DATAIN2, CLK, and DATAOUT1 to DATAOUT3.

FUNC1 has ports F1_IDT, CLK, F1_ODT1, and F1_OAD. F1_IDT is connected to DATAIN1 of TOP1. CLK is connected to CLK of TOP1. F1_ODT1 is connected to DATAOUT1 of TOP1. F1_OAD is connected to IP1_AD of IP1.

FUNC2 has ports F2_IDT1, F2_IDT2, CLK, and F2_ODT. F2_IDT1 is connected to IP1_ODT2 of IP1. F2_IDT2 is connected to DATAIN2 of TOP1. CLK is connected to CLK of TOP1. F2_ODT is connected to DATAOUT3 of TOP1.

IP1 has ports IP1_AD, CLK, IP1_ODT1, and IP1_ODT2. IP1_AD is connected to F1_OAD of FUNC1. CLK is connected to CLK of TOP1. IP1_ODT1 is connected to DATAOUT2 of TOP1. IP1_ODT2 is connected to F2_IDT1 of FUNC2.

Next, a circuit formed by separating IP1 of FIG. 9 from TOP1 by the computer will be described with reference 10.

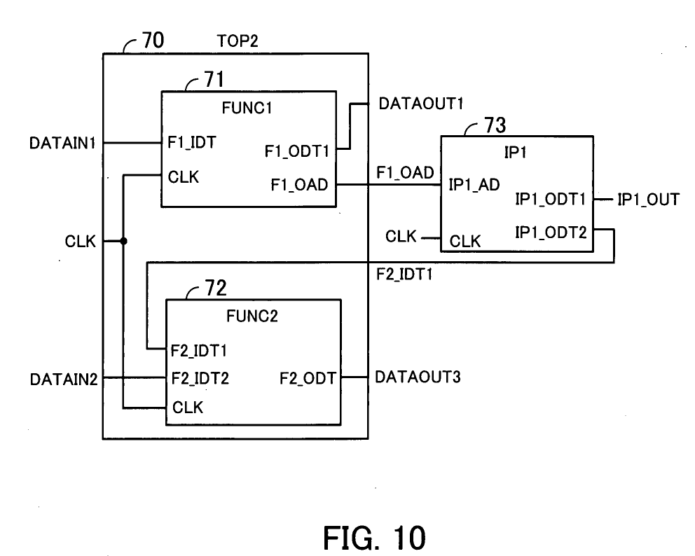

As shown in FIG. 10, the ports of TOP1 are changed after the separation of IP1 of FIG. 9 from TOP1. FIG. 10 shows a TOP circuit 70, and functional blocks 71 and 72 composing the TOP circuit 70. In addition, FIG. 10 shows an IP macro 73 separated from the TOP circuit 70. In the following description, the TOP circuit 70, the functional blocks 71 and 72, and the IP macro 73 are referred to as TOP2, FUNC1 and FUNC2, and IP1, as shown in FIG. 10.

TOP2 corresponds to TOP1 of FIG. 9. TOP2 comprises only FUNC1 and FUNC2 because IP1 has been separated therefrom. TOP2 has ports DATAIN1, DATAIN2, CLK, DATAOUT1, DATAOUT3, F1_OAD, and F2_IDT1.

FUNC1 corresponds to FUNC1 of FIG. 9. FUNC1 has pots F1_IDT, CLK, F1_ODT1, and F1_OAD, as in FUNC1 of FIG. 9. F1_IDT1 is connected to DATAIN1 of TOP2. CLK is connected to CLK of TOP2. F1_ODT1 is connected to DATAOUT1 of TOP2. F1_OAD is connected to F1_OAD of TOP2.

FUNC2 corresponds to FUNC2 of FIG. 9. FUNC2 has ports F2_IDT1, F2_IDT2, CLK, and F2_ODT, as in FUNC2 of FIG. 9. F2_IDT1 is connected to F2_IDT1 of TOP2. F2_IDT2 is connected to DATAIN2 of TOP2. CLK is connected to CLK of TOP2. F2_ODT is connected to DATAOUT3 of TOP2.

IP1 separated out of TOP2 has ports IP1_AD, CLK, IP1_ODT1, and IP1_ODT2, as in IP1 of FIG. 9. IP1_AD is connected to F1_OAD of TOP2. CLK is connected to external CLK. IP1_ODT1 is connected to external IP1_OUT. IP1_ODT2 is connected to F2_IDT1 of TOP2.

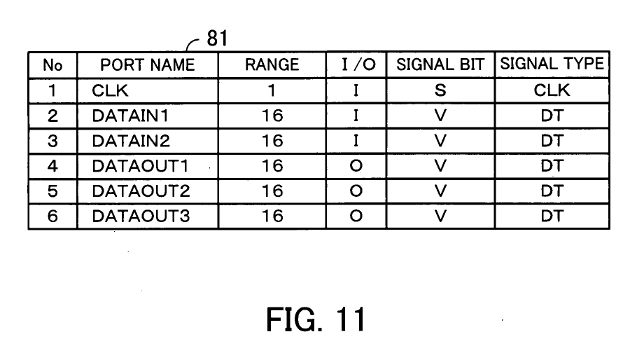

Now, port information files and a setting file to be inputted to a computer will be described. In addition to RTL of the circuit of FIG. 9, port information files of TOP1, FUNC1, FUNC2, and IP1, which will be described below, are inputted to the computer. First the port information file of TOP1 of FIG. 9 will be described with reference to FIG. 11.

A port information file 81 shown is a port information file of TOP1 of the circuit of FIG. 9. The port information file 81 has columns for entry number (No), port name, range, I/O, signal bit, and signal type.

The port name column stores the names of ports of TOP1. As described with FIG. 9, TOP1 has ports CLK, DATAIN1, DATAIN2, and DATAOUT1 to DATAOUT3, these names are stored in this port name column of the port information file 81.

The range column stores the bit widths of the ports. For example, it is confirmed that DATAIN1 has 16-bit width.

The I/O column stores information indicating whether the ports are input ports or output ports. In FIG. 11, “I” indicates an input port while “O” indicates an output port. For example, CLK is identified as an input port.

The signal bit column stores information indicating whether signals of the ports are single (one bit) or vector (plural bits). In FIG. 11, “S” indicates single while “V” indicates vector. For example, it is confirmed that signals of CLK are identified as single.

The signal type column stores the types of signals to be inputted to the ports. For example, clock signals are inputted to CLK, and therefore CLK indicating clock signals is stored in association with port name CLK. Since data signals are inputted to DATAIN1, DT indicating data signals is stored in association with port name DATAIN1.

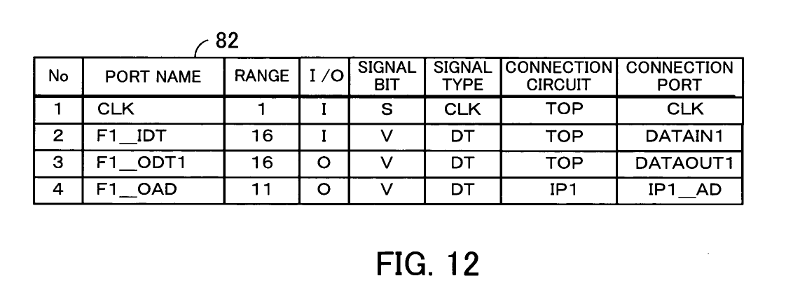

The port information file of FUNC1 of FIG. 9 will be described with reference to FIG. 12.

A port information file 82 shown is a port information file of FUNC1 of the circuit of FIG. 9. The port information file 82 has columns for entry number (No), port name, range, I/O, signal bit, signal type, connection circuit, and connection port.

The port name column stores the names of ports of FUNC1. As described with FIG. 9, FUNC1 has ports CLK, F1_IDT, F1_ODT1, and F1_OAD. These names are stored in this port name column of the port information file 82.

The range column stores the bit widths of the ports. The I/O column stores information indicating whether the ports are input ports or output ports. The signal bit column stores information indicating signals of the ports are single or vector. The signal type column stores the signal types of the ports.

The connection circuit column stores the names of circuits to which the ports of FUNC1 are connected. For example, F1_IDT is connected to DATAIN1 of TOP1 as shown in FIG. 9, and therefore TOP indicating TOP1 is stored in this connection circuit column in association with port name F1_IDT.

The connection port column stores the names of ports to which the ports of FUNC1 are connected. For example, F1_IDT is connected to DATAIN1 of TOP1 as shown in FIG. 9, and therefore DATAIN1 is stored in this connection port column in association with port name F1_IDT.

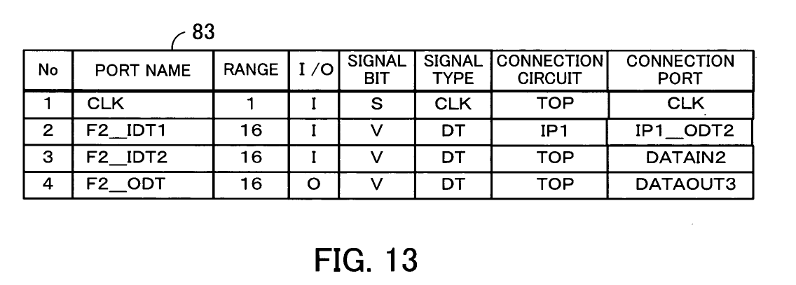

The port information file of FUNC2 of FIG. 9 will be described with reference to FIG. 13.

A port information file 83 shown is a port information file of FUNC2 of the circuit of FIG. 9. The port information file 83 has columns for entry number (No), port name, range, I/O, signal bit, signal type, connection circuit, and connection port.

The port name column stores the names of ports of FUNC2. As described with FIG. 9, FUNC2 has ports CLK, F2_IDT1, F2_IDT2, and F2_ODT. These names are stored in this port name column of the port information file 83.

The range column stores the bit widths of the ports. The I/O column stores information indicating whether the ports are input ports or output ports. The signal bit column stores information indicating whether signals of the ports are single or vector. The signal type column stores the signal types of the ports.

The connection circuit column stores the names of circuits to which the ports of FUNC2 are connected. For example, F2_IDT1 is connected to IP1_ODT2 of IP1 as shown in FIG. 9, and therefore IP1 is stored in this connection circuit column in association with port name F2_IDT1.

The connection port column stores the names of ports to which the ports of FUNC2 are stored. For example, F2_IDT1 is connected to IP1_ODT2 of IP1 as shown in FIG. 9, and therefore IP1_ODT2 is stored in this connection port column in association with port name F2_IDT1.

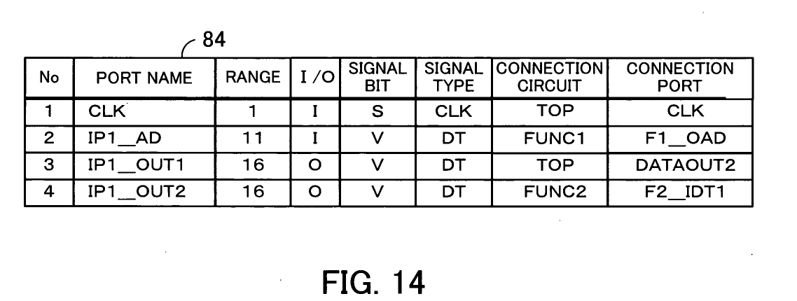

The port information file of IP1 of FIG. 9 will be described with reference to FIG. 14.

A port information file 84 shown is a port information file of IP1 of the circuit of FIG. 9. The port information file 84 has columns for entry number (No), port name, range, I/O, signal bit, signal type, connection circuit, and connection port.

The port name column stores the names of ports of IP1. As described with FIG. 9, IP1 has ports CLK, IP1_AD, IP1_OUT1, and IP1_OUT2, and these names are stored in this port name column of the port information file 84.

The range column stores the bit widths of the ports. The I/O column stores information indicating whether the ports are input ports or output ports. The signal bit column stores information indicating whether signals of the ports are signal or vector. The signal type column stores the signal types of the ports.

The connection circuit column stores the names of circuits to which the ports of IP1 are connected. For example, as shown in FIG. 9, IP1_AD is connected to F1_OAD of FUNC1, and therefore FUNC1 is stored in this connection circuit column in association with port name IP1_AD.

The connection port column stores the names of ports to which the ports of IP1 are connected. For example, as shown in FIG. 9, IP1_AD is connected to F1_OAD of FUNC1, and therefore F1_OAD is stored in this connection port column in association with port name IP1_AD.

It should be noted that the contents of the port information files 81 to 84 of FIGS. 11 to 14 are not limited to the above information, and other information can be included.

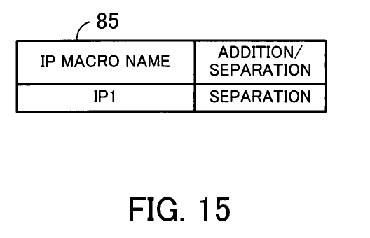

A setting file to be inputted to the computer will be described with reference to FIG. 15.

A setting file 85 shown has columns for IP macro name and addition/separation.

The IP macro name column stores the names of IP macros to be separated from or added to TOP1. In FIG. 15, IP1 of FIG. 9 is stored. The addition/separation column stores information indicating whether the IP macros stored in the IP macro name column are added or separated. In FIG. 15, information indicating separation is stored.

Port information files after the computer separates IP1 of FIG. 9 from TOP1 will be described.

As shown in FIG. 10, the computer separates IP1 based on the port information files of FIGS. 11 to 14, the setting file of FIG. 15, and RTL. At this time, the computer creates port information files that will now be described.

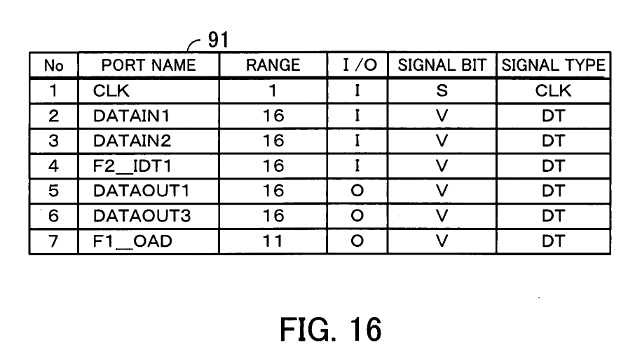

FIG. 16 shows a port information file of TOP1 after the separation.

A port information file 91 shown is a port information file of TOP2 after the separation of IP1. The port information file 91 has columns for entry number (No), port name, range, I/O, signal bit, and signal type.

The port name column stores the names of ports of TOP2. As described with FIG. 10, TOP2 has ports CLK, DATAIN1, DATAIN2, F2_IDT1, DATAOUT1, DATAOUT3, and F1_OAD. These names are stored in this port name column of the port information file 91.

The range column stores the bit widths of the ports. The I/O column stores information indicating whether the ports are input ports or output ports. The signal bit column stores information indicating whether signals of the ports are single or vector. The signal type column stores the signal types of the ports.

It should be noted that ports F2_IDT1 and F1_OAD are ports that are newly created by the separation of IP1.

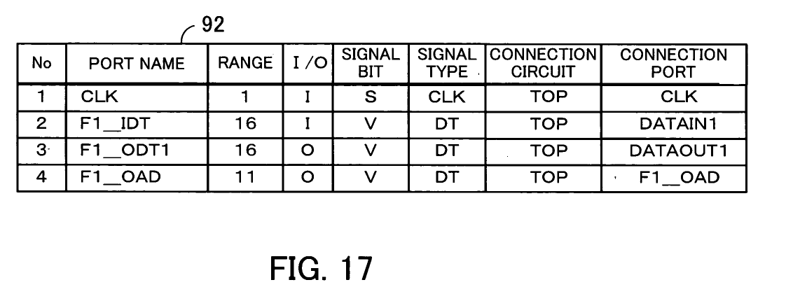

Now, the port information file of FUNC1 after the separation of IP1 will be described with reference to FIG. 17.

A port information file 92 shown is a port information file of FUNC1 after the separation of IP1. The port information file 92 has columns for entry number (No), port name, range, I/O, signal bit, signal type, connection circuit, and connection port.

The port name column stores the names of ports of FUNC1. As described with FIG. 10, FUNC1 has ports CLK, F1_IDT, F1_ODT1, and F1_OAD. These names are stored in this port name column of the port information file 92.

The range column stores the bit widths of the ports. The I/O column stores information indicating whether the ports are input ports or output ports. The signal bit column stores information indicating signals of the ports are single or vector. The signal type column stores the signal types of the ports.

The connection circuit column stores the names of circuits to which the ports of FUNC1 are connected. It should be noted that, since IP1 is separated out of TOP2, the connection circuit of port F1_OAD is changed from IP1 of FIG. 12 to TOP2, as shown in FIG. 17.

The connection port column stores the names of ports to which the ports of FUNC1 are connected. It should be noted that, since IP1 is separated out of TOP2, the connection port of port F1_OAD is changed from IP1_AD of IP1 of FIG. 12 to F1_OAD of TOP2, as shown in FIG. 17.

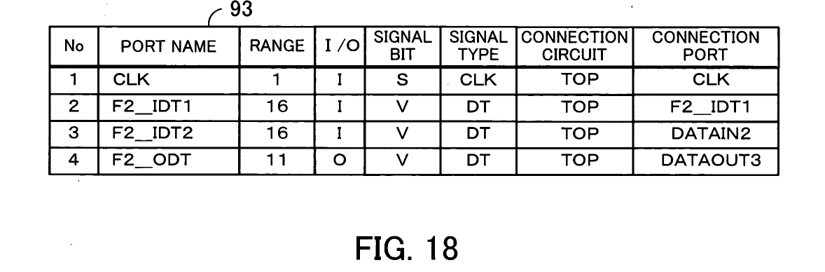

FIG. 18 shows the port information file of FUNC2 after the separation. A port information file 93 shown is a port information file of FUNC2 after the separation of IP1. The port information file 93 has columns for entry number (No), port name, range, I/O, signal bit, signal type, connection circuit, and connection port.

The port name column stores the names of ports of FUNC2. As described with FIG. 10, FUNC2 has ports CLK, F2_IDT1, F2_IDT2, and F2_ODT. These names are stored in this port name column of the port information file 93.

The range column stores the bit widths of the ports. The I/O column stores information indicating whether the ports are input ports or output ports. The signal bit column stores information indicating whether signals of the ports are single or vector. The signal type column stores the signal types of the ports.

The connection circuit column stores the names of circuits to which the ports of FUNC2 are connected. It should be noted that, since IP1 is separated out of TOP2, the connection circuit of port F2_IDT1 is changed from IP1 of IP1 of FIG. 13 to TOP, as shown in FIG. 18.

The connection port column stores the names of ports to which the ports of FUNC2 are connected. It should be noted that, since IP1 is separated out of TOP2, the connection port of port F2_IDT1 is changed from IP1_ODT2 of IP1 of FIG. 13 to F2_IDT1 of TOP2, as shown in FIG. 18.

As described above, when IP1 of FIG. 9 is separated from the TOP circuit as shown in FIG. 10, the port information files of FIGS. 16 to 18 are created. The computer creates RTL of TOP2 of FIG. 10 based on the port information files of FIGS. 16 to 18.

Now, RTL that is created when the computer separates IP1 of FIG. 9 from the TOP circuit as shown in FIG. 10 will be described.

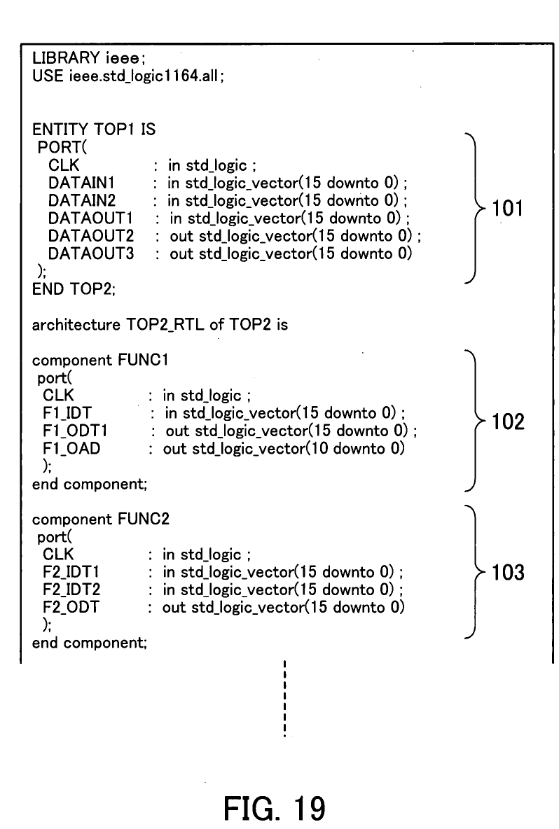

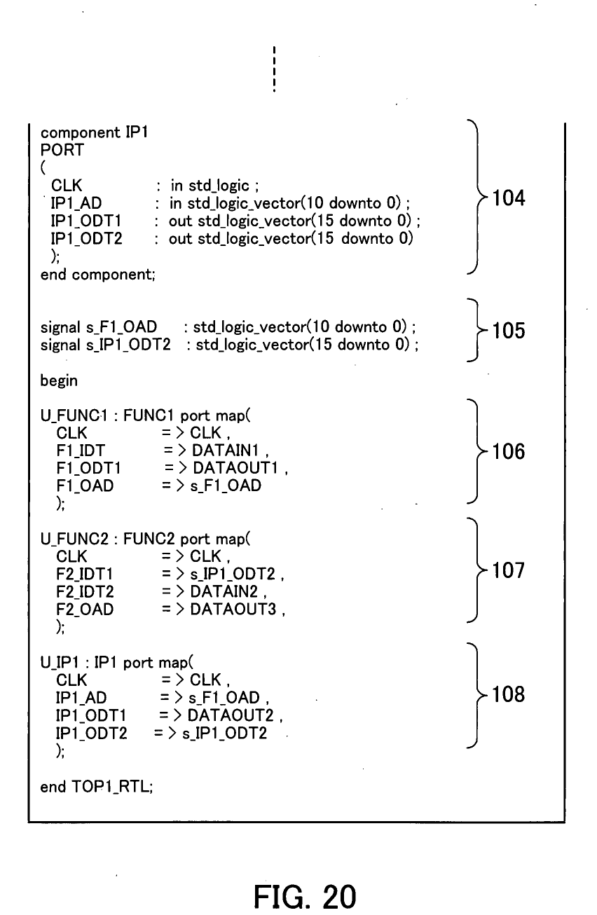

FIGS. 19 and 20 show RTL of TOP1 to be inputted to the computer. The RTL is written in VHDL by way of example. The description of FIG. 20 follows that of FIG. 19

In the RTL of TOP1, a part 101 describes the ports of TOP1. Parts 102 to 104 describe the ports of FUNC1, FUNC2, and IP1, which compose TOP1. A part 105 describes the signal lines within TOP1. Parts 106 to 108 describe the connection ports to which the ports of FUNC1, FUNC2, and IP1 are connected.

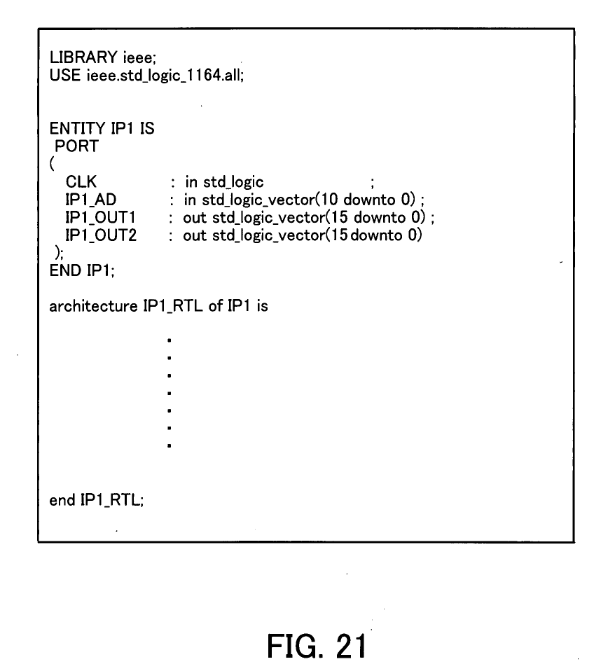

FIG. 21 shows RTL of IP1 to be inputted to the computer. The RTL is written in VHDL by way of example. The part after “architecture IP1_RTL of IP1 is” describes the entity of IP1. Similarly, the entities of FUNC1 and FUNC2 are also described in RTL and are to be inputted to the computer.

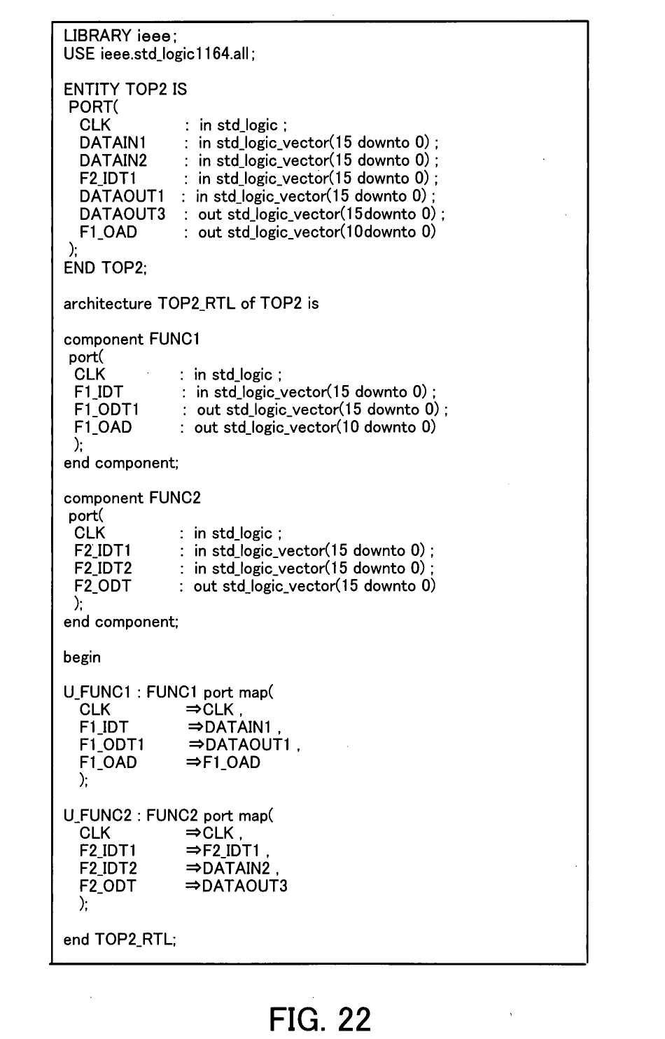

FIG. 22 shows RTL of TOP1 from which IP1 has been separated. Since IP1 has been separated from TOP1, the computer creates RTL of TOP2 as shown in FIG. 22. Since the functions of FUNC1 and FUNC2 are not changed, the RTL describing the entities of FUNC1 and FUNC2 is not changed.

Now, a method of creating the port information files 91 to 93 of FIGS. 16 to 18 will be specifically described.

The computer first opens a port information file of an IP macro to be separated, which is specified by a setting file. By searching the connection circuit column of the opened port information file, the computer obtains the connection circuit names other than TOP and the connection port names associated therewith.

It is now assumed that IP1 is to be separated from TOP1, as described with FIGS. 9 and 10. In this case, as shown in FIG. 15, the setting file 85 specifies separation of IP1. The computer opens the port information file 84 of IP1 of FIG. 14 based on the setting file 85.

By searching the connection circuit column of the opened port information file 84, the computer obtains the connection circuit names other than TOP and the connection port names associated therewith. In the case of FIG. 14, the computer obtains circuit names FUNC1 and FUNC2 and connection port names F1_OAD and F2_IDT1 from the connection circuit column and the connection port column of entry numbers 2 and 4 of the port information file 84.

The computer opens the port information files corresponding to the obtained circuit names. In this example, since the computer obtains the circuit names FUNC1 and FUNC2, the computer opens the port information files 82 and 83 of FIGS. 12 and 13.

The computer searches the port name column of the opened port information files for the obtained connection port names. The computer changes the connection circuit names associated with the found port names to TOP. Thereby the target IP macro is separated out of the TOP circuit. The computer also changes the connection port names associated with the connection circuit names changed to TOP, to port names that are the same as the obtained connection port names.

In the case of the above example, the computer searches the port name column of the opened port information file 82 for the obtained connection port name F1_OAD. The computer changes the connection circuit name associated with the found port name F1_OAD to TOP. In addition, the computer changes the associated connection port name to the same name as the port name F1_OAD. Thereby the port information file 92 of FIG. 17 is created.

Similarly, the computer searches the port name column of the opened port information file 83 for the obtained connection port name F2_IDT1. The computer changes the connection circuit name associated with the found port name F2_IDT1 to TOP. In addition, the computer changes the associated connection port name to the same name as the port name F2_IDT1. Thereby the port information file 93 of FIG. 18 is created.

By changing the connection circuit names of FUNC1 and FUNC2 to TOP, the port information file of TOP1 also should be changed. Since the ports of IP1 that were connection ports of FUNC1 and FUNC2 are changed to F2_IDT1 and F1_OAD of TOP1, F2_IDT1 and F1_OAD are added to the port name column of the port information file of TOP1. Thereby the port information file 91 of FIG. 16 is created.

It should be noted that the range, I/O, signal bit, and signal type columns of the port information file 91 associated with the port names F2_IDT1 and F1_OAD are filled in based on the port information files 92 and 93 of FUNC1 and FUNC2.

In addition, the computer creates the RTL of FIG. 22 based on the port information files 91 to 93 created above.

The following description is about how to create the above port information files.

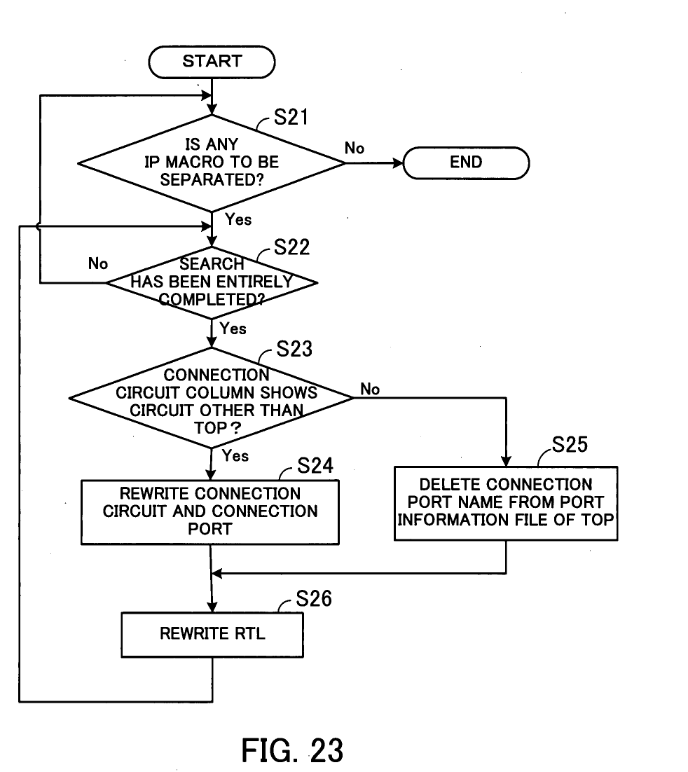

FIG. 23 is a flowchart showing how to create port information files when an IP macro is separated.

(Step S21) The computer determines based on an inputted setting file whether an IP macro to be separated is specified. As described with FIGS. 9 and 10, not one but some IP macros may be specified as IP macros to be separated. If there is an IP macro to be separated, the computer opens the port information file of the IP macro, and the procedure goes on to step S22. If there is no IP macro to be separated, the procedure is completed.

(Step S22) The computer determines whether the connection circuit column of the opened port information file has been entirely searched. If yes, the procedure goes on to step S23, and otherwise goes back to step S21.

(Step S23) The computer determines whether the target connection circuit column of a target entry of the port information file opened at step S22 shows a circuit (the circuit name of a functional block) other than TOP. If yes, the computer obtains the connection circuit name and the connection port name associated therewith, and the procedure goes on to step S24. If the connection circuit column of the target entry shows TOP, the computer obtains the connection circuit name and the connection port name associated therewith, and the procedure goes on to step S25.

(Step S24) The computer opens the port information file corresponding to the connection circuit name obtained at step S23, and searches the port name column of the opened port information file for the connection port name obtained at step S23. The computer rewrites the connection circuit name of the connection circuit column associated with the found port name, to TOP, and rewrites the associated connection port name to the obtained connection port name (the connection port name obtained at step S23).

(Step S25) If the connection port name obtained at step S23 has no more connection to another circuit, the computer deletes the obtained connection port name from the connection port names of the port information file of TOP. For example, the computer deletes a port name DATAOUT2 from the port information file 81 of FIG. 11, and thereby creates the port information file 91 of FIG. 16.

(Step S26) The computer rewrites the RTL descriptions of the ports of TOP based on the port information files.

In this way, the port information files after an IP macro is separated are created and RTL is rewritten.

The above description is about how the computer separates an IP macro. The next description is about how the computer adds an IP macro.

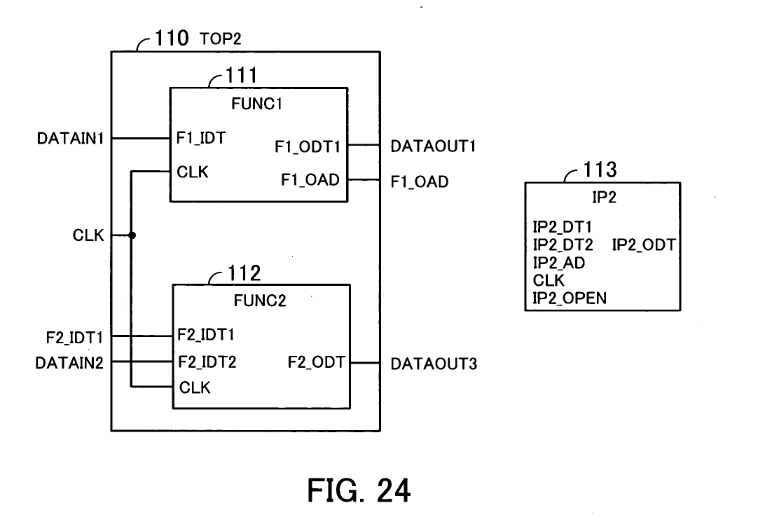

FIG. 24 shows a circuit before the computer adds an IP macro. This figure shows a top-layer TOP circuit 110 described in RTL, and functional blocks 111 and 112 composing the TOP circuit 110. In addition, an IP macro 113 to be added to the TOP circuit 110 is shown. In the following description, the TOP circuit 110, the functional blocks 111 and 112, and the IP macro 113 are referred to as TOP2, FUNC1, FUNC2, and IP2, respectively, as shown in FIG. 24.

Referring to FIG. 24, TOP2 has ports DATAIN1, DATAIN2, CLK, F2_IDT1, DATAOUT1, DATAOUT3, and F1_OAD.

FUNC1 and FUNC2 have the same ports as FUNC1 and FUNC2 of FIG. 9. F1_IDT of FUNC1 is connected to DATAIN1 of TOP2. CLK is connected to CLK of TOP2. F1_ODT1 is connected to DATAOUT1 of TOP2. F1_OAD is connected to F1_OAD of TOP2.

F2_IDT1 of FUNC2 is connected to F2_IDT1 of TOP2. F2_IDT2 is connected to DATAIN2 of TOP2. CLK is connected to CLK of TOP2. F2_ODT is connected to DATAOUT3 of TOP2.

IP2 has ports IP2_DT1, IP2_DT2, IP2_AD, CLK, IP2_OPEN, and IP2_ODT.

The next description is about a circuit with IP2 of FIG. 24 added to TOP2 by the computer.

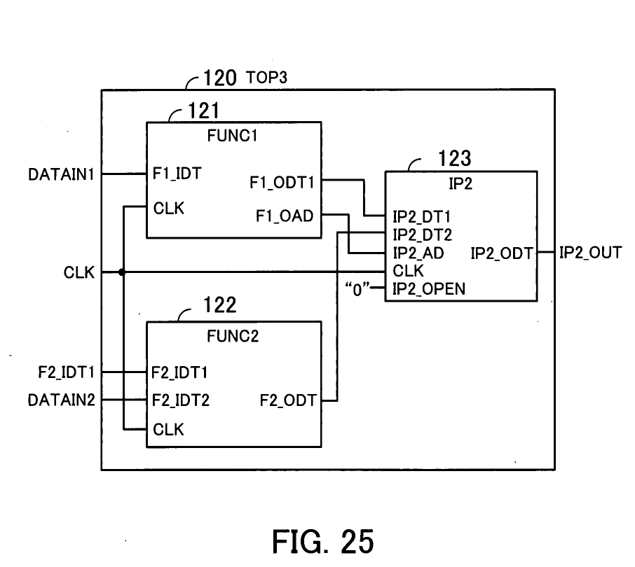

FIG. 25 shows a circuit after the computer adds IP2. FIG. 25 shows TOP circuit 120, functional blocks 121 and 122 composing the TOP circuit 120, and an IP macro 123 added to the TOP circuit 120. In the following description, the TOP circuit 120, the functional blocks 121 and 122, and the IP macro 123 are referred to as TOP3, FUNC1, FUNC2, and IP2, respectively, as shown in FIG. 25.

TOP3 corresponds to TOP2 of FIG. 24. Since IP2 has been added to TOP3, TOP3 has ports DATAIN1, DATAIN2, CLK, F2_IDT1, and IP2_OUT. IP2_OUT of TOP3 is connected to IP2_ODT of IP2.

FUNC1 corresponds to FUNC1 of FIG. 24. As in FUNC1 of FIG. 24, FUNC1 has ports F1_IDT, CLK, F1_ODT1, and F1_OAD. F1_ODT1 and F1_OAD of FUNC1 are connected to IP2_DT1 and IP2_AD of IP2, respectively, after the addition of IP2.

FUNC2 corresponds to FUNC2 of FIG. 24. As in FUNC2 of FIG. 24, FUNC2 has ports F2_IDT1, F2_IDT2, CLK, and F2_ODT. F2_ODT of FUNC2 is connected to IP2_DT2 after the addition of IP2.

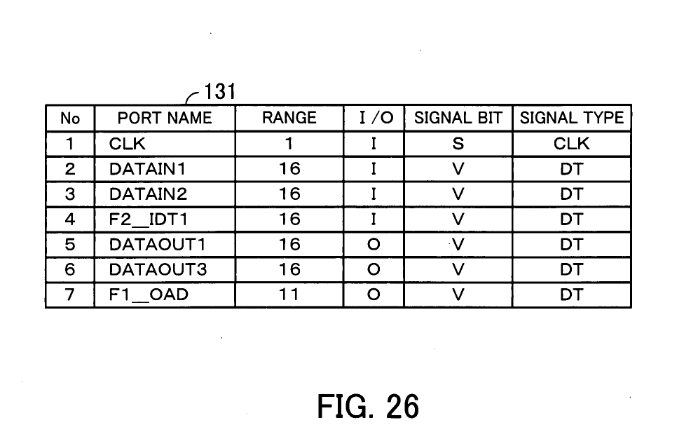

Now, port information files and a setting file to be inputted to the computer will be described. To the computer, the port information files of TOP2, FUNC1, FUNC2, and IP2, which will be described now, are inputted together with the RTL of the circuit of FIG. 24. The port information file of TOP2 of FIG. 24 will be first described with reference to FIG. 26.

A port information file 131 shown is a port information file of TOP2 of FIG. 24, and has columns for entry number (No), port name, range, I/O, signal bit, and signal type.

The port name column stores the names of ports of TOP2. As described with FIG. 24, TOP2 has ports DATAIN1, DATAIN2, CLK, F2_IDT1, DATAOUT1, DATAOUT3, and F1_OAD. These names are stored in this port name column of the port information file 131.

The range column stores the bit widths of the ports. The I/O column stores information indicating whether the ports are input ports or output ports. The signal bit column stores information indicating whether signals of the ports are signal or vector. The signal type column stores the signal types of the ports.

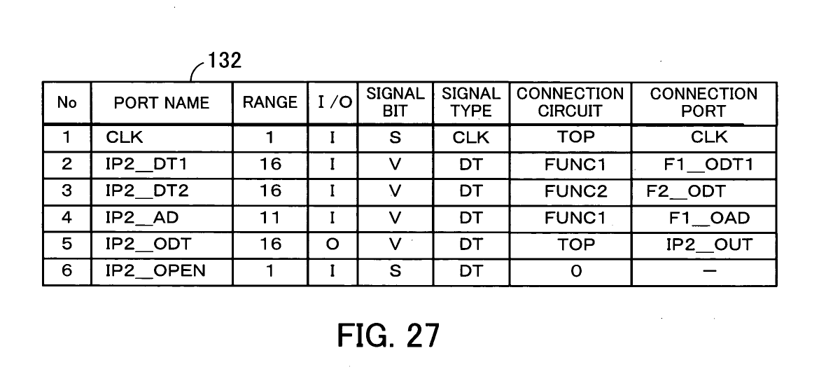

The port information file of IP2 of FIG. 24 to be inputted to the computer will now be described with reference to FIG. 27.

A port information file 132 shown is a port information file of IP2 of FIG. 24, and has columns for entry number (No), port name, range, I/O, signal bit, signal type, connection circuit, and connection port.

The port name column stores the names of ports of IP2. As described with FIG. 24, IP2 has ports IP2_DT1, IP2_DT2, IP2_AD, CLK, IP2_OPEN, and IP2_ODT. These names are stored in this port name column of the port information file 132.

The range column stores the bit widths of the ports. The I/O column stores information indicating whether the ports are input ports or output ports. The signal bit column stores information indicating whether signals of the ports are single or vector. The signal type column stores the signal types of the ports.

The connection circuit column stores the names of circuits to which the ports are to be connected when IP2 is added to TOP2. The connection port column stores the names of ports to which the ports are to be connected when IP2 is added to TOP2. “0” in the connection circuit column of the port IP2_OPEN indicates that the port is to be fixed at L level. If “1” is stored in the connection circuit column, the port is to be fixed at H level.

The contents of the port information files 131 and 132 of FIGS. 26 and 27 are not limited to the above information but also other information can be included. On the other hand, the port information files of FUNC1 and FUNC2 of FIG. 24 are identical to the port information files 92 and 93 of FIGS. 17 and 18 (because TOP circuit 110 and TOP circuit 70 have identical formations), and therefore explanation for them is omitted.

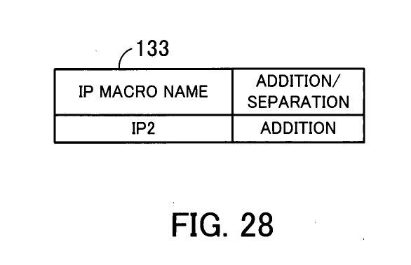

A setting file to be inputted to the computer will now be described with reference to FIG. 28. A setting file shown has columns for IP macro name and addition/separation.

The IP macro name column stores the names of IP macros to be added to or separated from TOP2. In this example, IP2 of FIG. 24 is stored. The addition/separation column stores information whether the IP macros stored in the IP macro column are to be added or separated. In this example, information indicating addition is stored.

Port information files after the computer adds IP2 of FIG. 24 to TOP2 will now be described.

The computer adds IP2 to TOP3 as shown in FIG. 25, based on the port information files 131 and 132 of TOP2 and IP2 of FIGS. 26 and 27, the port information files 92 and 93 of FUNC1 and FUNC2 (FIGS. 17 and 18), the setting file 133 of FIG. 28, and the RTL of the circuit of FIG. 24. At this time, the computer creates port information files after the addition as described below.

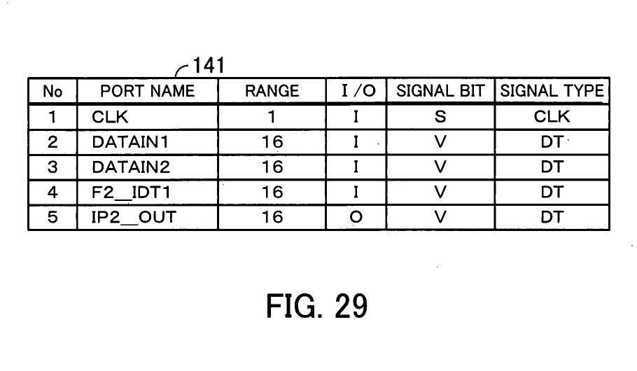

FIG. 29 shows a port information file of TOP3 after addition. A port information file 141 shown is a port information file of TOP3 after the addition of IP2. The port information file 141 has columns for entry number (No), port name, range, I/O, signal bit, and signal type.

The port name column stores the names of ports of TOP3. As described with FIG. 25, TOP3 has ports CLK, DATAIN1, DATAIN2, F2_IDT1, and IP2_OUT. These names are stored in this port name column of the port information file 141.

The range column stores the bit widths of the ports. The I/O column stores information indicating whether the ports are input ports or output ports. The signal bit column stores information indicating whether signals of the ports are single or vector. The signal type column stores the signal types of the ports.

The port information file of FUNC1 after the addition of IP2 will now be described.

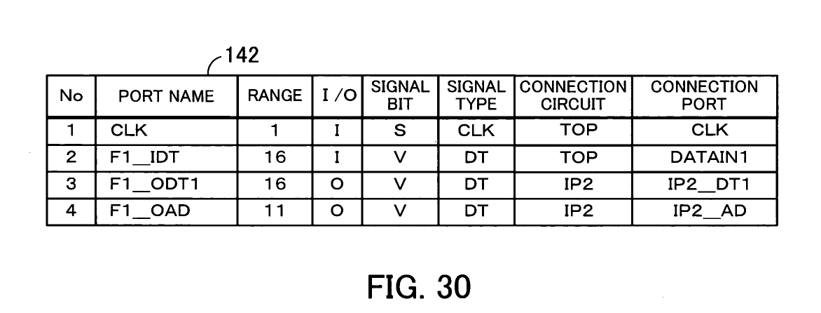

FIG. 30 shows a port information file of FUNC1 after addition. A port information file 142 shown is a port information file of FUNC1 after the addition of IP2. The port information file 142 has columns for entry number (No), port name, range, I/O, signal bit, signal type, connection circuit, and connection port.

The port name column stores the names of ports of FUNC1. As described with FIG. 25, FUNC1 has ports CLK, F1_IDT, F1_ODT1, and F1_OAD. These names are stored in this port name column of the port information file 142.

The range column stores the bit widths of the ports. The I/O column stores information indicating whether the ports are input ports or output ports. The signal bit column stores information indicating whether the signals of the ports are single or vector. The signal type column stores the signal types of the ports.

The connection circuit column stores the names of circuits to which the ports of FUNC1 are connected. It should be noted that the addition of IP2 to TOP3 changes the connection circuits of the ports F1_ODT1 and F1_OAD from TOP of FIG. 17 to IP2 as shown in FIG. 30.

The connection port column stores the names of ports to which the ports of FUNC1 are connected. It should be noted that the addition of IP2 to TOP3 changes the connection ports of the ports F1_ODT1 and F1_OAD from DATAOUT1 and F1_OAD of TOP of FIG. 17 to IP2_DT1 and IP2_AD of IP2 as shown in FIG. 30.

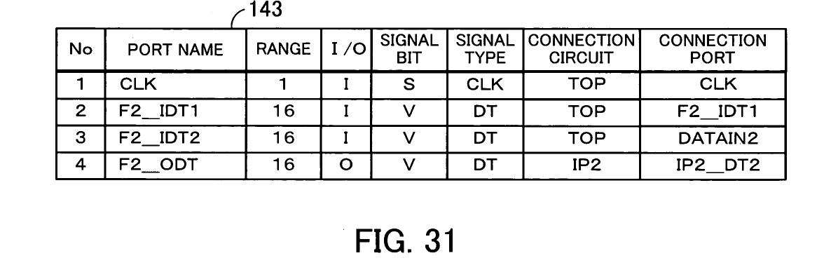

FIG. 31 shows a port information file of FUNC2 after addition. A port information file 143 shown is a port information file of FUNC2 after the addition of IP2. The port information file 143 has columns for entry number (No), port name, range, I/O, signal bit, signal type, connection circuit, and connection port.

The port name column stores the names of ports of FUNC2. As described with FIG. 25, FUNC2 has ports CLK, F2_IDT1, F2_IDT2, and F2_ODT. These names are stored in this port name column of the port information file 143.

The range column stores the bit widths of the ports. The I/O column stores information indicating whether the ports are input ports or output ports. The signal bit column stores information indicating whether signals of the ports are single or vector. The signal type column stores the signal types of the ports.

The connection circuit column stores the names of circuits to which the ports of FUNC2 are connected. It should be noted that the addition of IP2 to TOP3 changes the connection circuit of the port F2_ODT from TOP of FIG. 18 to IP2 as shown in FIG. 31.

The connection port column stores the names of ports to which the ports of FUNC2 are connected. It should be noted that the addition of IP2 to TOP3 changes the connection port of the port F2_ODT from DATAOUT3 of TOP of FIG. 18 to IP2_DT2 of IP2 as shown in FIG. 31.

As described above, when IP2 of FIG. 24 is added to TOP3 as shown in FIG. 25, the port information files of FIGS. 29 to 31 are created.

Now, RTL to be created when the computer adds IP2 of FIG. 24 to TOP3 as shown in FIG. 25 will be described.

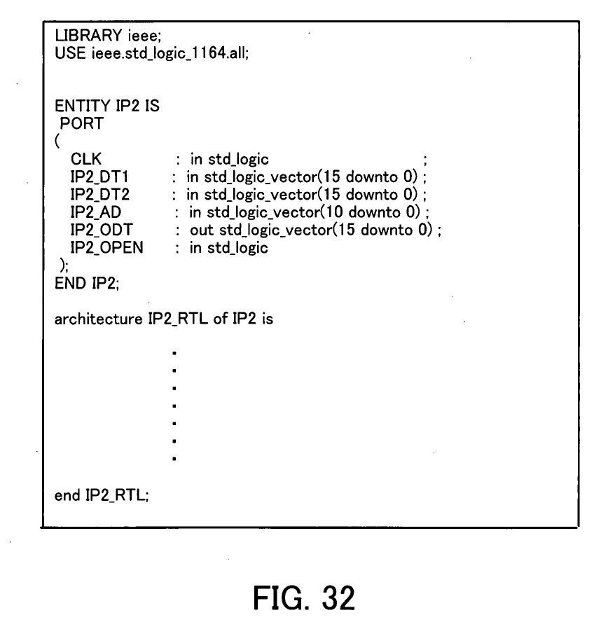

FIG. 32 shows RTL of IP2 to be inputted to the computer. The RTL is written in VHDL by way of example. The part following “architecture IP2_RTL of IP2 is” describes the entity of IP2. It should be noted that the RTL of TOP2 is inputted to the computer as well. The RTL of TOP2 is the same with FIG. 22, and therefore its explanation is omitted. This is because the TOP circuits of FIGS. 10 and 24 are identical. In addition, the entities of FUNC1 and FUNC2 are descried in RTL and are inputted to the computer.

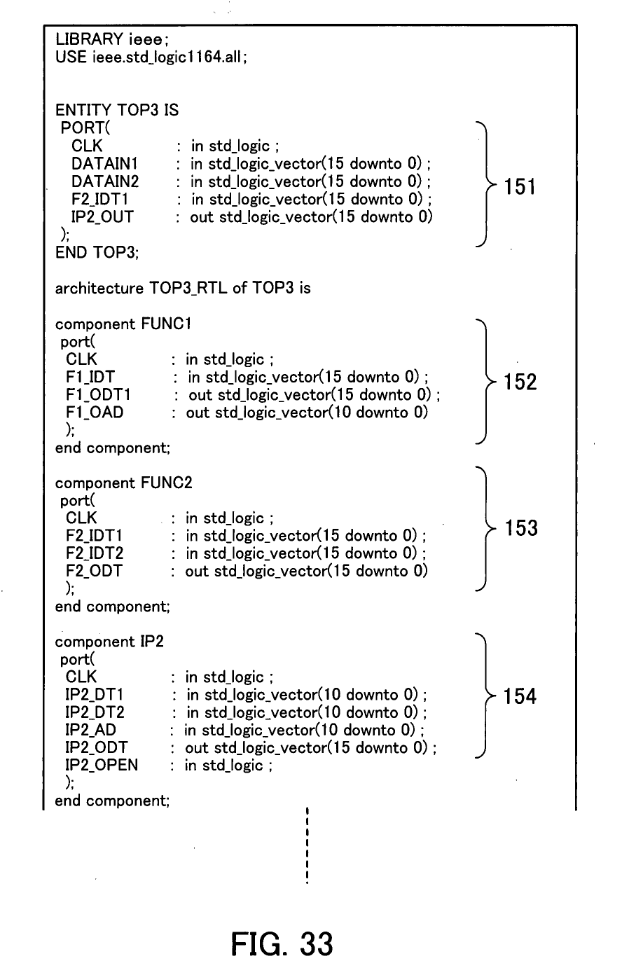

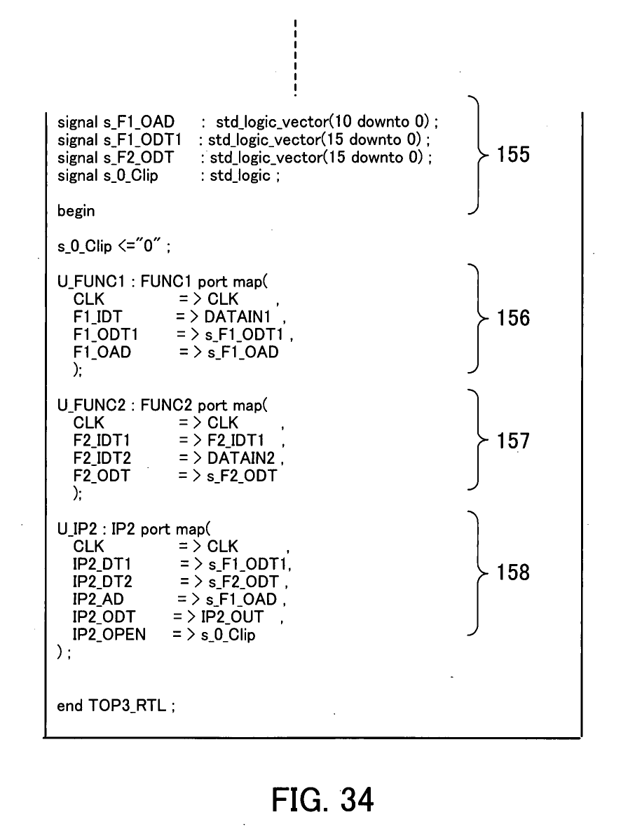

FIGS. 33 and 34 show RTL of TOP3 with IP2 added thereto. The RTL is written in VHDL by way of example. In this connection, the description of FIG. 34 follows that of FIG. 33.

In the RTL of TOP3, a part 151 describes the ports of TOP3. The part 151 corresponds to the port information file 131 of FIG. 26. Parts 152 to 154 describe the ports of FUNC1, FUNC2, and IP2 composing TOP3. A part 155 describes the signal lines within TOP3. Parts 156 to 158 show the connection ports to which the ports of FUNC1, FUNC2, and IP2 are connected.

Now, a method of creating the port information files 141 to 143 of FIG. 29 to FIG. 31 will be described in detail.

The computer opens the port information file of an IP macro to be added, specified by a setting file. The computer searches the connection circuit column of the opened port information file to obtain connection circuit names other than TOP, and also obtains the port names and connection port names associated with the obtained connection circuit names.

For example, as described with FIGS. 24 and 25, it is now assumed that IP2 is added to TOP3. In this case, as shown in FIG. 28, the setting file 133 specifies addition of IP2. The computer opens the port information file 132 of IP2 of FIG. 27, based on the setting file 133.

The computer obtains connection circuit names other than TOP in the connection circuit column of the opened port information file 132, and also obtains the port names and connection port names associated with the connection circuit names. In the case of FIG. 27, the computer obtains port names IP2_DT1, IP2_DT2, and IP2_AD in association with entry numbers 2 to 4 of the port information file 132. In addition, the computer obtains FUNC1 and FUNC2 as the connection circuit names, and obtains F1_ODT1, F2_ODT, and F1_OAD as the connection port names. Furthermore, the computer obtains a value 0 as a connection circuit name other than TOP in the connection circuit column, and the associated port name IP2_OPEN.

The computer can recognize how to change the port information files, such as which ports of which circuits should be changed to which ports of IP2, based on the port names, connection circuit names, and connection port names obtained from the port information file 132. For example, based on the port name, the connection circuit name, and connection port name in association with entry number 2 of the port information file 132, the computer can recognize that the connection port of the port F1_ODT1 of FUNC1 should be changed to the IP2_DT1 of IP2.

The computer opens the port information files corresponding to the obtained connection circuit names. In the above example, the computer obtains the connection circuit names FUNC1 and FUNC2, so that the computer opens the port information files 92 and 93 of FIGS. 17 and 18.

The computer searches the port name column of the opened port information files for the obtained connection port names. The computer changes the connection circuit column associated with the found port names to the name of the IP macro. Thereby the target IP macro is surely added to the TOP circuit. The computer changes the connection port name column associated with the connection circuit column changed to the IP macro, to the obtained port names of the IP macro to be added.

In the case of the above example, the computer searches the port name column of the opened port information file 92 for the obtained connection port name F1_ODT1. Then, the computer changes the connection circuit column associated with the found port name F1_ODT1, to IP2. In addition, the computer changes the associated connection port name to the obtained port name IP2_DT1 of the IP macro to be added. The computer performs the same process for the other obtained connection port names F1_OAD and F2_ODT.

Since the connection circuits of FUNC1 and FUNC2 has been changed to IP2, the port information file 131 of TOP2 of FIG. 26 also should be changed. Since the ports of FUNC1 and FUNC2 which were connected to TOP are connected to ports of IP2, the port names are deleted from the port information file 131 of TOP2.

For example, since the ports F1_ODT1 and F1_OAD of FUNC1 and F2_ODT of FUNC2 are changed to be connected to ports of IP2, so that DATAOUT1, F1_OAD, and DATAOUT3 of TOP2 which were the connection ports of these ports are deleted from the port information file 131.

In addition, the computer determines whether the connection port names of the port information file 132 of IP2 of FIG. 27 which are connected to TOP exist in the port information file 131 of TOP2. If such connection port names do not exist in the port information file 131 of TOP2, the computer adds the connection port names to the port information file 131. That is to say, the computer adds the names of ports that are directly connected from IP2 to TOP2. For example, entry number 5 of the port information file 141 of FIG. 29 is newly added. In this way, the port information file 141 of FIG. 29 is created.

Based on thus created port information file 141, the computer creates RTL of FIGS. 33 and 34.

The following description is about how the computer creates port information files.

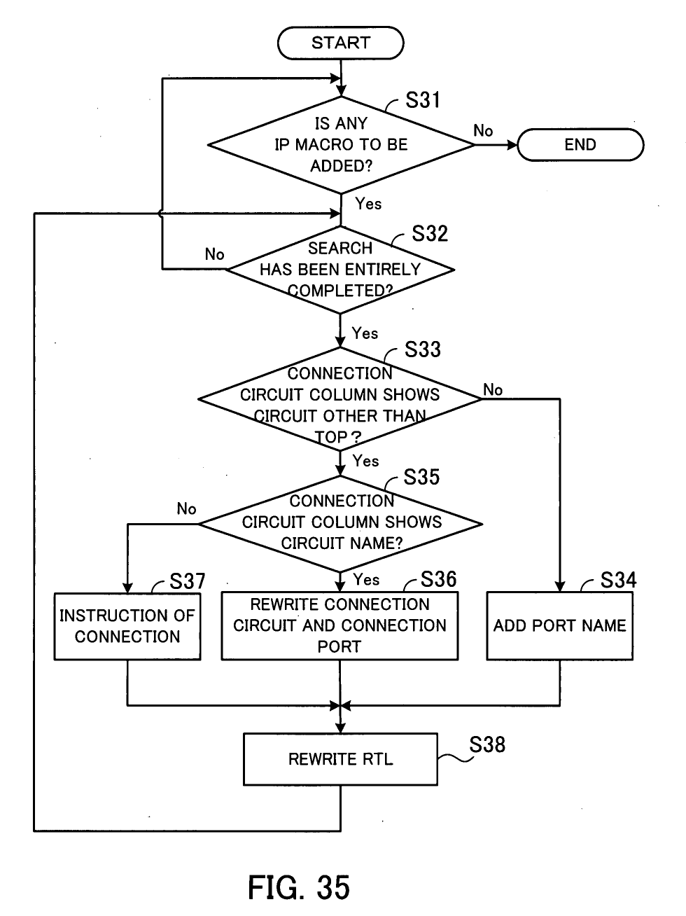

FIG. 35 is a flowchart showing how to create port information files when an IP macro is added.

(Step S31) The computer determines based on an inputted setting file whether there is an IP macro to be added. As described with FIGS. 24 and 25, the number of IP macros to be added is not limited to one and some IP macro may be added. If there is an IP macro to be added, the computer opens the port information file of the IP macro and the procedure goes on to step S32. If there is no IP macro to be added, this procedure is completed.

(Step S32) The computer determines whether the connection circuit column of the opened port information file has been entirely searched. If yes, the procedure goes on to step S33, and otherwise goes on to step S31.

(Step S33) The computer determines whether the connection circuit column of a target entry of the port information file opened at step S32 shows a circuit other than TOP. If yes, the computer obtains the associated port name, connection circuit name, and connection port name, and then the procedure goes on to step S35. If the connection circuit column of the target entry shows TOP, the computer obtains the associated connection port name, and then the procedure goes on to step S34.

(Step S34) If the connection port name obtained at step S33 does not exist in the port name column of the port information file 131 of TOP2 of FIG. 26, the computer adds the connection port name.

(Step S35) The computer determines whether the connection circuit column obtained at step S33 shows a circuit name. If yes, the procedure goes on to step S36, and otherwise goes on to step S37.

(Step S36) The computer opens a port information file corresponding to the circuit name of the connection circuit column obtained at step S33. The computer searches the port name column of the opened port information file for the connection port name obtained at step S33. The computer rewrites the connection circuit column associated with the found port name to the name of the IP macro to be added, and also rewrites the associated connection port column to the port name obtained at step S33.

(Step S37) The computer creates RTL of TOP based on the connection circuit column obtained at step S33. For example, if the connection circuit column stores “0”, the computer fixes the port of the IP macro to be added, to L level. If the connection circuit column stores “1”, the computer fixes the port of the IP macro to be added, to H level. If the connection circuit column stores “OPEN”, the computer fixes the port of the IP macro to be added, to be open. For example, in entry number 6 of the port information file 132 of FIG. 27, the connection circuit column stores “0”, so that the computer fixes the port (IP2_OPEN in FIG. 27) of the IP macro to L level.

(Step S38) The computer rewrites the RTL descriptions of the ports of TOP based on the port information files.

In this way, when an IP macro is added, the port information files are created and RTL is rewritten.

As described above, based on the port information file of an IP macro to be added to or separated from a TOP circuit, the port information files of the TOP circuit and the functional blocks are changed, and RTL of the TOP circuit is rewritten. Thereby RTL of the TOP circuit with the IP macro added thereto or separated therefrom can be obtained automatically, not manually, thus resulting in separating the IP macro from the TOP circuit with ease.

In addition, RTL is automatically created by the computer, which can prevent errors that may be made by manual operation and improve efficiency, and yet can reduce the number of repetitions of processes.

It should be noted that, to add and separate IP macros, the computer separates and then adds the IP macros, or adds and then separates the IP macros. The addition and separation can be performed in the above described way.

Further, for the case where a designed circuit has a circuit scale exceeding a scale allowable in a device, Japanese Unexamined Patent Publication No. 2004-372972 proposes a logical circuit division method and apparatus for dividing a circuit. Therefore, if addition/separation of IP macros to/from a TOP circuit increases the circuit scale of the TOP circuit to a circuit scale unusable in a device, this logical circuit division method and apparatus may be used to divide the TOP circuit. In addition, for the case where addition/separation of IP macros to/from a TOP circuit increases the number of pins of the TOP circuit to a number unusable in a device, the above logical circuit division method and apparatus may be used to divide the circuit.

By the way, the computer can convert the port statement of created RTL to have a format usable for the layout purpose or the like, and output the RTL.

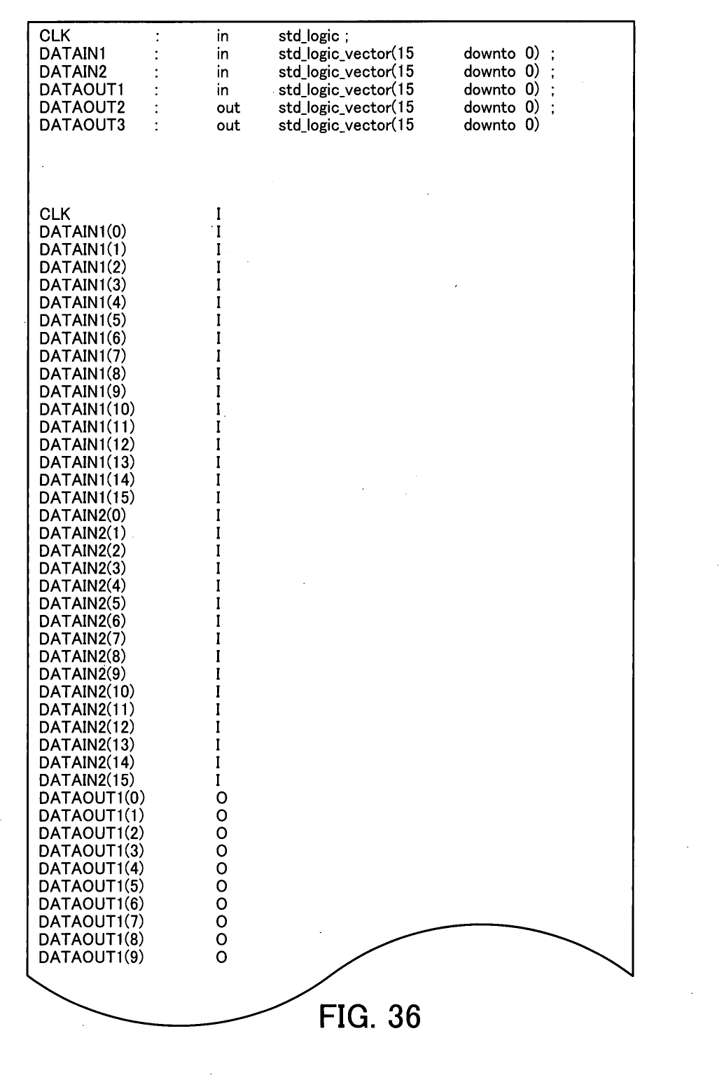

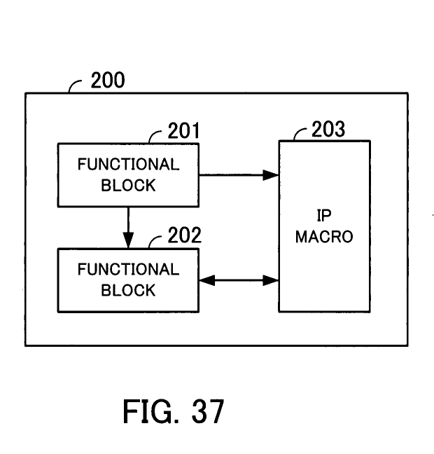

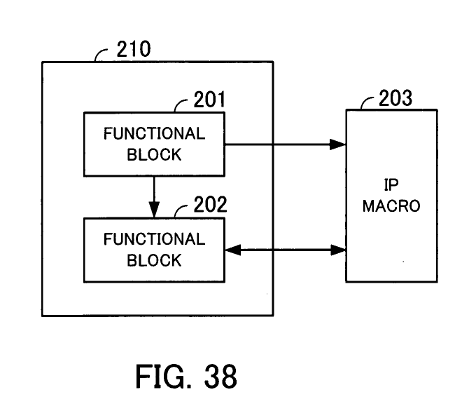

FIG. 36 shows conversion of the port format. The computer can convert the format of the port statement of created RTL as shown in FIG. 36, and output the RTL.

In short, the computer of this invention changes the port information of a TOP circuit and block circuits based on the port information of a separation block circuit to be separated out of the TOP circuit, to thereby create separation port information after the separation block circuit is separated, and rewrites RTL of the TOP circuit. Thereby RTL of the TOP circuit from which the separation block circuit has been separated can be obtained, without manual operation, thereby resulting in separating the block circuit from the TOP circuit with ease.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer for designing a circuit, comprising:
port information input means for inputting port information of a TOP circuit described in register transfer level (RTL) and block circuits composing the TOP circuit;
separation information input means for inputting separation information specifying a separation block circuit to be separated out of the TOP circuit;
separation port information creation means for creating separation port information after the separation block circuit is separated, by changing the port information of the TOP circuit and the block circuits based on the port information of the separation block circuit to be separated according to the separation information; and
RTL rewriting means for rewriting the RTL of the TOP circuit from which the separation block circuit has been separated, based on the separation port information.

2. The computer according to claim 1, wherein the port information includes names of ports, names of connection circuits to which the ports are connected, and names of connection ports to which the ports are connected.

3. The computer according to claim 2, wherein the separation port information creation means obtains, from the port information of the separation block circuit, a connection circuit name that identifies any one of the block circuits and a connection port name associated with the obtained connection circuit name, searches the port names of the port information of the block circuit identified by the obtained connection circuit name, to find a port name that is identical to the obtained connection port name, and changes a connection circuit name associated with the found port name, to the TOP circuit.

4. The computer according to claim 3, wherein the separation port information creation means further changes to the obtained connection port name a connection port name associated with the found port name in the port information of the block circuit identified by the obtained connection circuit name.

5. The computer according to claim 1, further comprising:
addition information input means for inputting addition information specifying an addition block circuit to be added to the TOP circuit;
addition port information creation means for creating addition port information after the addition block circuit is added, by changing the port information of the TOP circuit and the block circuits based on the port information of the addition block circuit to be added according to the addition information; and
RTL creation means for creating the RTL of the TOP circuit with the addition block circuit added thereto, based on the addition port information.

6. The computer according to claim 5, wherein the port information has information including names of ports, names of connection circuits to which the ports are connected, and names of connection port to which the ports are connected.

7. The computer according to claim 6, wherein the addition port information creation means obtains, from the port information of the addition block circuit, a connection circuit name that identifies any one of the block circuits, and a connection port name and a port name associated with the obtained connection circuit name, searches the port names of the port information of the block circuit identified by the obtained connection circuit name, to find a port name that is identical to the obtained connection port name, and changes a connection circuit name associated with the found port name, to the addition block circuit.

8. The computer according to claim 7, wherein the addition port information creation means further changes to the obtained port name a connection port name associated with the found port name in the port information of the block circuit identified by the obtained connection circuit name.

9. The computer according to claim 6, wherein, in a case where a connection circuit name of the port information of the addition block circuit specifies a prescribed state, the RTL rewriting means rewrites the RTL so as to get a port identified by a port name associated with the connection circuit name into the prescribed state.

10. The computer according to claim 1, further comprising a circuit scale dividing means for dividing the TOP circuit if the TOP circuit exceeds a circuit scale allowable in a device.

11. The computer according to claim 1, further comprising pin quantity dividing means for dividing the TOP circuit if the TOP circuit exceeds the number of pins allowable in a device.
